(19) United States
(12) Patent Application Publication
(10) Pub. No.: US 2014/0244293 A1
(43) Pub. Date: Aug. 28, 2014

(54) METHOD AND SYSTEM FOR PROPAGATING LABELS TO PATIENT ENCOUNTER DATA

(71) Applicant: 3M INNOVATIVE PROPERTIES COMPANY, St. Paul, MN (US)

(72) Inventor: Victor T. Jones, III, Germantown, MD (US)

(73) Assignee: 3M INNOVATIVE PROPERTIES COMPANY, St. Paul, MN (US)

(21) Appl. No.: 13/773,835

(22) Filed: Feb. 22, 2013

(51) Int. Cl. G06F 19/00

(52) U.S. Cl. CPC G06F 19/322
USPC 705/3

(57) ABSTRACT

Methods and systems for propagating labels, such as “good” or “bad”, to unlabeled patient encounter data. Patient encounters, partially labeled but mostly unlabeled, is represented as nodes in a network, and labels are propagated from labeled nodes to unlabeled nodes based on the similarity of the unlabeled nodes to neighboring nodes. The resulting patient encounter data may be used for, for example, a training data set, or for other purposes.

### BACKGROUND

Confidence Assessment Modules (CAMs), as used in a clinical coding context, are computer implemented modules that assess the probability that codes associated with a patient's encounter with a healthcare organization accurately reflect the patient's encounter. CAMs do this by assessing whether the codes are consistent with what a professional coder would assign. Such codes may be automatically generated, as described in Kapit et. al. (US Patent Publication No. 2008/0004505), through an analysis of encounter-related documentation. The codes may then be used to generate bills without further human review if, upon review by the CAM, there is a sufficiently high probability that the codes accurately reflect the patient's encounter with the healthcare organization. If the CAM determines an insufficient probability, then the encounter-related documentation may be queued up for human review, by a professional coder. The CAM, and the process of “training” the CAM by processing human-reviewed data using machine learning techniques is further described in Kapit.

### BRIEF SUMMARY

Systems and methods for propagating labels to unlabeled patient encounter data. Such patient encounter data may include data describing a patient's encounter with a healthcare organization and codes resulting therefrom. Labels associated with such patient encounter data may indicate whether or the degree to which the codes automatically assigned to the encounter, as part of a natural language processing system, are consistent with codes that would be assigned by a professional human coder. For example, the labels may be “good” or “bad”—good indicating a human coder, upon review, did not have to change them; bad meaning there was a change that was needed. In various circumstances, it may be necessary or advantageous to propagate, or assign, labels to a set of unlabeled clinical patient encounter data.

In one embodiment, a computer-implemented method of propagating labels to a set of clinical encounter data id described, the computer having at least one processor and memory, and the method comprising receiving a set of labeled coded encounter data, each coded encounter including encounter-related features associated with a patient's encounter with a healthcare organization and a set of codes associated with the encounter-related features, and each coded encounter including a label indicative of a label attribute; receiving a set of unlabeled patient encounter data; and, using at least one of the computer's processors, algorithmically propagating labels to the set of unlabeled patient encounter data based on the set of labeled patient encounter data, to produce resulting labeled coded encounter data.

Systems are also described that implement the above referenced process.

This and other embodiments are described further herein.

### BRIEF DESCRIPTION OF DRAWINGS

FIG. 1 is a diagram of a clinical label propagation system 10;

FIG. 2 is a flowchart showing a high-level process label propagation system 10 uses to propagate labels;

FIG. 3 is a flowchart showing further process details;

FIG. 4 is a graph representing patient encounters as nodes on the graph;

FIG. 5 is a graph representing patient encounters as nodes on the graph;

FIG. 6 is a graph representing patient encounters as nodes on the graph;

FIG. 7 is a graph representing patient encounters as nodes on the graph;

FIG. 8 is a graph representing patient encounters as nodes on the graph; and,

FIG. 9 is a graph representing patient encounters as nodes on the graph.

In the figures, like reference numerals designate like elements.

### DETAILED DESCRIPTION OF ILLUSTRATIVE EMBODIMENTS

To sufficiently “train” a CAM using machine learning techniques as described in Kapit, a sufficiently large data set, or training corpus, should be used. This data set might include, for example, encounter-related documentation associated with some number of encounters, as well as the resulting codes associated with the encounter, the resulting codes ensuing from some type of review of the encounter-related documentation (either by computer or by human). The encounter-related documentation includes the documents and data generated as a result of a patient's encounter with a healthcare organization, or any subset thereof. For example, it may include an attending doctor's dictation that describes the patient's condition and the services rendered to the patient. The encounter-related documentation may be processed to extract encounter-related features from the encounter-related documentation. Encounter-related features are portions, or snippets, of the encounter-related documentation determined to be of likely relevance to coding. For example, an attending doctor's dictation might be as follows:

“Xray finger. Three views of the left hand show no evidence of fracture or dislocation.”

The encounter-related features (i.e., snippet) that may be extracted from this dictation would include “xray”, “finger”, “3 views”, “left”, and “hand”. “Finger” overrides “hand” because it is more specific in the exam title, and “fracture” and “dislocation” may be discarded because of the phrase “no evidence of.” So the resulting snippet would be “xray—finger—3 views—left”. This snippet may be automatically associated with an CPT diagnosis or procedure code of 73140-LT, which is “X-RAY EXAM OF FINGER(S)” with the “LT” modifier indicating left side.

Extraction of the constituent components of the snippet are common to many natural language processing (NLP) programs, and is well known in the art. Generally speaking, the process involves extraction of metadata (such as the ordered exam title information (which may differ from what the doctor dictated), patient age and gender, and other relevant demographic data). Then various sections of the dictation may be identified, for example the exam title, clinical indication, and final impression sections. Next, known or likely medical vocabulary may be identified and tagged. The text may be parsed by one or more parser algorithms to carry out syntactic analysis of the text to determine relationships among the identified vocabulary and clinical concepts, and to identify negated sections of the text, etc. The parser also assists in linking the clinical concepts to clinically relevant evidence.

The data set that includes the encounter-related features, (e.g. the snippets—there could be multiple evidence snippets that are extracted: some for procedures, some for diagnoses, etc.) and the resulting codes is termed herein a “coded encounter.” The codes being referred to may be any codes that are associated with the encounter-related features, but in the descriptions included herein they may be considered more narrowly billing-relevant codes, such as those provided by the International Classification of Diseases (ICD) published by the World Health Organization. Such codes are common referred to as either ICD-9 or 10 codes. Other sets of codes include the Current Procedural Terminology, or CPT, codes, provided by the American Medical Association. Auto-coded encounters are coded encounters wherein the codes have been generated automatically by a computer's analysis of the encounter-related features. Such auto-coders are known in the art; see for e.g. U.S. Pat. No. 6,915,254. In some embodiments, the encounter-related features are the same as the encounter-related documentation, but in usual practice the encounter-related features comprise some processed sub-set of the encounter-related documentation.

The precise number of coded encounters necessary to sufficiently train a CAM using machine learning techniques may be dependent on a number of variables, such as the variability of the encounter-related documentation and the population of possible associated codes (to name just a couple). For a more complete discussion of the trade-off involved, see “How Does the System Know It's Right? Automated Confidence Assessment for Compliant Coding” by Yuankai Jiang, PhD; Michael Nossal, M A; and Philip Resnik, PhD. (http://library.ahima.org/xpedio/groups/public/documents/ahima/bok1_{—}032075. pdf visited Feb. 8, 2013).

In some instances it is thought that about 20,000 coded encounters is a sufficiently sized training data set that will produce a CAM having adequate performance characteristics (foremost, accuracy). The process of training the CAM, briefly, comprises presenting coded encounters to a machine learning algorithm, each coded encounter being characterized, or labeled, as “good” (meaning the codes would likely not be changed if audited by a professional coder) or “bad” (meaning the codes likely would be changed if audited by a professional coder). The characterization of “good” or “bad” may be inferred, when professional coders are involved in reviewing computer-generated codes, by comparing the degree to which the coder needed to modify a computer-suggested code base. If there were essentially no modifications, the coded encounter may be labeled “good”; if there were modifications the coded encounter may be labeled “bad.” The machine learning algorithm may beneficially learn from both good and bad coded encounters. Though label attributes of “good” and “bad” are discussed herein, it is recognized that other label attributes could be employed.

Ideally an initial training data set to first train a CAM, i.e. 20,000 coded encounters, will have ideally been reviewed (and corrected as needed) by a professional coder. Such review provides a high quality training data set for initially configuring the CAM. Such a quality-assurance type review assures high confidence that the coded encounters have codes that properly reflect the encounter-related documentation. An initially trained CAM may provide years of service to an organization, reviewing coded encounters (usually auto-coded encounters) and determining a confidence level for each.

Auto-coded encounters associated with a high enough confidence level may be sent “direct-to-bill”, that is, the codes may be provided to further billing systems to generate invoices that are submitted to payment organizations (usually insurers or the government), without professional coder review. In some implementations, 85% of auto-coded encounters (possibly even more) may be sent direct-to-bill based on the review of a CAM. In most implementations, a percentage of auto-coded encounters sent direct-to-bill, for example, 2-5%, may be routinely reviewed by professional coders, as a quality control check. These coders may make no changes to the auto-coded encounter, or they may make changes. Additionally, all auto-coded encounters judged by the CAM to be not direct-to-bill (i.e., CAM has lower confidence in them), are reviewed by professional coders.

From time to time it may be advantageous to retrain a previously trained, deployed CAM. For example, sometimes the feed of encounter-related documentation may change for one reason or another (for example, perhaps a new or altered system is put in place that collects or generates some of this encounter-related documentation). In such a situation, there might be a decrease in percentage of auto-coded encounters that have a high enough confidence level to be sent direct-to-bill. In other situations, issues prompting possible CAM retraining may exhibit themselves as an increasing percentage of auto-coded encounters that are changed upon review by a professional coder (as part of the quality assurance function mentioned above), i.e., an increasing percentage of “bad” auto-coded encounters. In yet other situations, the auto-coding engine may have improved and been upgraded over time, but the decisions made by the CAM do not reflect these improvements.

In any such a scenario, where it is recognized that the CAM should be retrained, it may not be feasible to have such a large set (i.e., 20,000 coded encounters) of human-reviewed coding data as was used for the initial training. This is because human review is slow and costly. Typically only a small fraction of what is ideally needed to retrain a CAM is available, resultant from quality-assurance type reviews mentioned above (where the CAM marked the auto-coded encounter as direct-to-bill—high confidence), or from human review that takes place if the CAM did not send direct-to-bill—(CAM has lower confidence). For example, it may be the case that only 200 or so direct-to-bill (i.e., high confidence) coded encounters have had professional quality control-type review out of 20,000 auto-coded encounters (given a 2% quality assurance (i.e. human review) rate, and a 50% direct-to-bill, or “capture” rate). Additionally, the 10,000 encounters not sent direct-to-bill would have had professional review as part of the normal workflow—that is, if the CAM judges them not direct-to-bill, they are then reviewed by a professional.

Described herein are systems and methods for preparing a training data set which may be used to retrain a CAM based off of an initial set of coded encounters the majority of which are (initially) not labeled. For example, consider the above mentioned initial set of coded encounters, 20,000 total, wherein 200 of the total are both high confidence (i.e., CAM judged they should go direct-to-bill) and labeled as a result of the quality assurance review by professional coders. The 200, then, would have a label of “good” (that is, high confidence the codes do accurately represent associated encounter-related features—no or very minor changes needed to be made by the professional coder upon review of the auto-coded encounter), and “bad” coded encounter (that is, insufficient level of confidence of the same, where the professional coder needed to make changes to the auto-coded encounter). The systems and methods described herein allow the 200 labeled auto-coded quality-assured encounters to be used as an initial seed data set which is used to then propagate labels to the remaining 9,800 unlabeled auto-coded encounters that were also deemed of high-enough confidence for the CAM to have sent them direct-to-bill. The resultant 10,000 (9800+200) labeled encounters are then combined with the 10,000 auto-coded encounters that were not judged by the CAM as having the requisite confidence level to be sent direct-to-bill (and thus received professional coder review as part of the normal workflow—includes both good and bad labels). The result is a training data set of 20,000 labeled coded encounters, which may then be used to retrain a CAM using known machine learning algorithms.

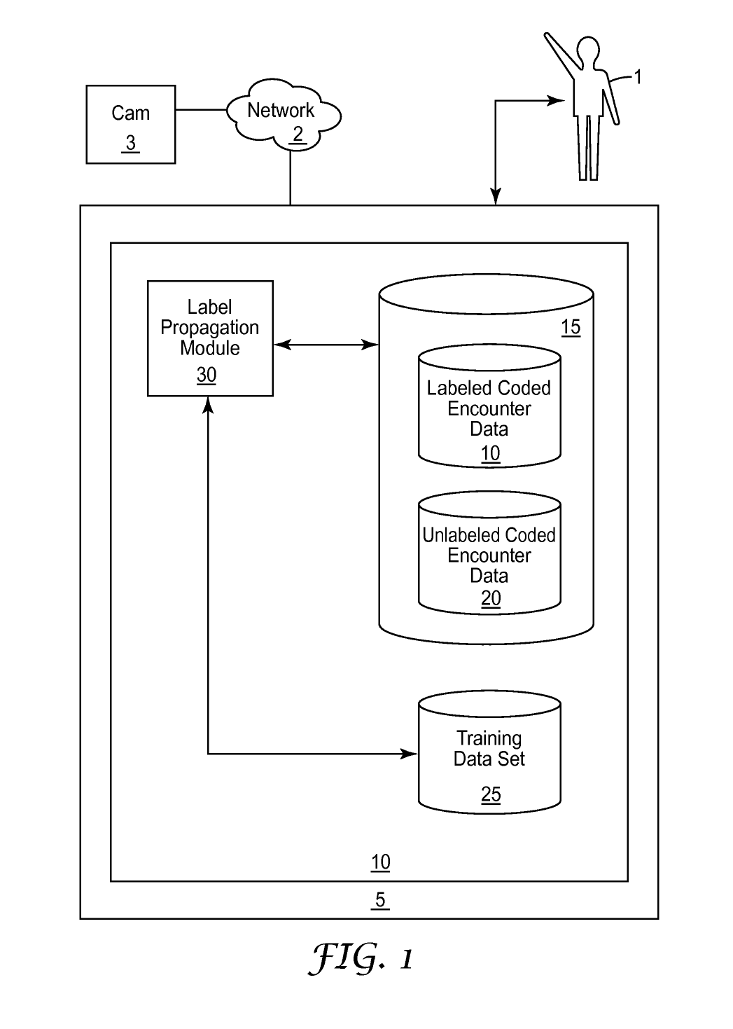

FIG. 1 shows a representation of a clinical billing label propagation system 10. Clinical label propagation system 10 includes a number of function and storage modules. The functionality of the functional modules, in particular the label propagation module 30, will be described in greater detail later in this description. Storage modules include labeled coded encounter data 10, unlabeled coded encounter data 20 (which together comprise the initial set of coded encounters 15), as well as training data set 25 (which, for the purposes of illustration, is initially unpopulated but will hold the resultant training data set). Label propagation module 30, communicatively coupled to the data sets 15 and 25, propagates labels to unlabeled coded encounter data, putting resultant labeled coded encounter data into training data set 25, along with the labeled coded encounter data 10. Data sets are stored in databases or any type of data storage and retrieval system, such as files, an object-oriented database, or a relational database.

Clinical billing label propagation system 10 is implemented as a software module on computer system 5. User 1 may interact with label propagation module 30 through a user interface provided by computer 5. Network 2 connects the clinical billing label propagation system 10 to confidence assessment module 3, which includes its own training processes. The resulting training data set 25 may be exported or otherwise provide to the retraining-processes associated with CAM 3.

Label propagation system 10 is shown as software being executed on physical computer system 5. The software is contained on a non-transitory computer-readable medium such as a hard drive, computer memory, a CD-ROM, a DVD, or any other computer-readable medium. Physical computer system 5 is a personal computer. In another embodiment it is a server computer that interacts with user 1 in a client-server type computing environment (such architecture is not depicted in FIG. 1). Though shown residing on one physical computing system 5, other embodiments may have various components of the clinical billing label propagation system 10 operating on different, communicatively coupled computers. Physical computer system 5 includes an operating system (not shown in FIG. 1) to allocate processing, memory, network, and other computing resources to clinical billing label propagation system 10.

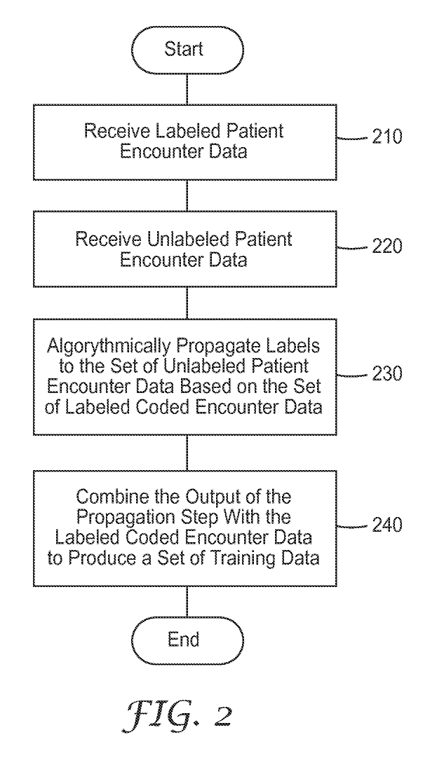

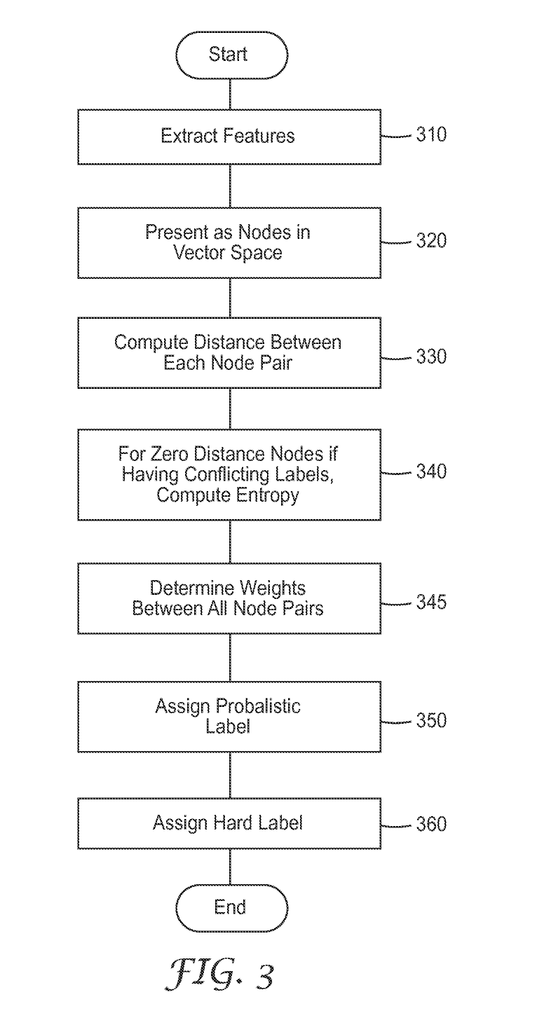

FIG. 2 shows a high-level flowchart of the process by which a training data set may be prepared by way of label propagation. First, labeled, auto-coded encounter data is received. As mentioned above, in the case of 20,000 encounters, and assuming a 50% capture rate, 10,000 of the encounters would have been judged “direct-to-bill” by a CAM. And further assuming a 2% quality control (i.e., human review) rate, this would mean 200 auto-coded encounters that may be considered labeled “good” or “bad.” This would also mean 9800 patient encounters are unlabeled (step 220). Next, labels are propagated to the 9800 unlabeled patient encounters (step 230). This process is described in greater detail with respect to FIG. 3, below. Finally, the 9800 newly labeled encounters are combined with the 200 to create a training data set of 10,000. This training set may then be combined with the 10,000 encounters that were not judged direct-to-bill and were reviewed by the professional coder as part of the standard workflow (i.e., these 10,000 may also be considered labeled “good” or “bad”). The resultant data set is 20,000 coded encounters, each labeled either “good” or “bad.”

Turning now to FIG. 3, a flow-chart is shown that expands upon step 230 in FIG. 2. Features are first extracted from the 10,000 encounters (step 310). Particular features could include the ICD and CPT codes associated with the encounter, the number of each type of code assigned, the evidence used to assign those codes (including radiologic modality and number of views, the body parts involved, whether contrast was used, symptoms, etc.), certain facts about how the auto-coding engine processed the evidence (including for e.g. whether the auto-coding engine used a statistics or rules-based approach to assessing the evidence at various steps in the process, what part of the encounter various evidence comes from, etc.), statistics about the general likelihood of the codes being assigned, checks for sex and gender mismatches between codes and the patient (for example, a male cannot have a hysterectomy), patient information (age and gender), etc. In one embodiment, there are up to 70 model features that are extracted from each encounter. The model features extracted are the same features extracted by the CAM (though in practice a CAM may be individually configured to use something less than all 70 features depending on implementation).

Next, the 10,000 encounters are represented in the memory of computer system 5 as nodes in a network in a 70-dimension (or however many features there are) vectors space, wherein the feature list for each encounter is a vector in that vector space, with the distance between nodes in one dimension a function of the similarity between the nodes with respect to a feature.

(Step 320). This process is known in the art, and is described by Xiaojin Zhu and Zoubin Ghahramani, “Learning from Labeled and Unlabeled Data with Label Propagation,” Technical Report CMU-CALD-02-107, Carnegie Mellon University, 2002 (available at http://www.cs.cmu.edu/˜zhuxj/pub/CMU-CALD-02-107.pdf, visited Feb. 14, 2013).

The distance between the vectors for every pair of encounters is then computed (step 330). Different metrics may be used for such computation. For example, it has been found that a simply binary, or discreet, metric whereby the distance in each dimension is either 0 (items have the same value) or 1 (they differ) is effective. The total distance between each pair of vectors is computed as the square root of the sum of the distances for all the dimensions, or in the case of the binary metric, more simply, the square root of the number of dimensions in which the two vectors differ.

Following the known teachings of Zhu, in order to compute the parameter a which is used by the label propagation algorithm a minimum spanning tree (MST) is built on the network defined by the list of vectors and the pair-wise distances between them. The MST is built up by considering the distances between nodes in the network in the order of shortest to longest, and all nodes start out unconnected. If the connection connects (directly or indirectly) two previously unconnected nodes in the network, it is added to the MST. If a connection connects two already indirectly connected nodes, it is discarded. MSTs are a well-known computer science data structure. In Zhu's original implementation, the MST-building process is stopped when the sub-trees being connected contain differing labels (keeping in mind that most nodes are unlabeled). The distance between nodes that connects differently labeled nodes is d0, and σ=d0/3.

In our implementation, as compared with Zhu's, encounter data includes instances where oppositely labeled nodes may be identical (i.e., two oppositely labeled nodes have the same feature vectors and thus have distance 0 between them), so d0=0, and σ=0. That is, a “good” and a “bad” encounter may have the same set of extracted features. (This ideally does not ordinarily happen, but in this realm of data, where there is a subjective element to picking codes, it does—can be the result of simple human error). Zhu's described algorithm is unequipped to handle this phenomenon. Rather than stop the MST-building process when joining sub-trees with oppositely labeled nodes (as Zhu would prescribe), the process described herein takes a more complex approach.

The entropy of the labeled nodes in a sub-tree is computed. Entropy, H, is defined as:

$$H ( X ) = - {\sum }_{i = 1}^{n} P ( {x}_{i} ) log ( P ( {x}_{i} ) )$$

Where X is the variable we are computing the entropy of, and x₀ . . . xₙ are the different values of X—in this case, these are the labels (so, n=2). P is the probability mass function X, so in our case, P(“good”) is the percentage of “good” labels in the sub-tree of the MST, and P(“bad”) is the percentage of “bad” labels in the sub-tree of the MST.

We also count, L, the number of labeled nodes in the new sub-tree.

Our stopping condition to find d0 is when L*H≧5% of the total number of labeled nodes. When that occurs, the distance for the last connecting edge is d0, and σ=d0/3 as before. We thus compute the distance between all node pairs.

Next, using a, we convert the distances between the network nodes into connection weights for all node pairs, with “distant” nodes (those with a distance more than a given greatly discounted weights) (step 345):

$$w = exp ( - \frac{{d}^{2}}{{σ}^{2}} )$$

Using these new connection weights between nodes, labels are propagated around the network of encounters, from labeled to unlabeled nodes (step 350). Once again following Zhu, this entails:
(1) Building a probabilistic transition matrix, T, based on the network connection weights), with a smoothing element.
(2) Applying T to a matrix, Y, composed of the existing labels, to get a new version of Y.
(3) Re-normalizing the rows of Y so that they are proper probability distributions.
(4) “Clamping” the original labeled data (so that the human-derived labels don't change).
(5) Repeating until the stopping criteria are met (for e.g., this could be that a change in Y from one iteration to the next is below some threshold, or a maximum number of iterations has occurred.)
(6) Finally, the “soft” probabilistic labels in Y are interpreted as “hard” labels by assigning whichever label value has the highest probability. (So, 60% “good” and 40% “bad” is interpreted as a “hard”, non-probabilistic label “good”.)

There are many possible similarity relations that could be used rather than our binary, discreet metric (difference is 0 if values are equal, 1 if they are different). For example, one could use a metric based on distance in a feature-based vector space, which could be Euclidean distance for numerical values (as will be used in a hypothetical example, below). The distance function could also be weighted, such that some elements of the feature vector count more than others. The feature weighting in the distance function could depend on many things, including weighting by a human expert, value in distinguishing between node types (“good” or “bad” in our use), or dissimilarity to other features, among other things.

Also, the vector space distances can be converted to weights in numerous ways, (including the one listed in Zhu in equation 1), but in general a greater distance translates to a lesser weight. Other similarity relations exist, but may not apply as well to clinical encounter-type data.

There are different update or propagation methods that could be employed, with one of the simplest being a weighted average of the labels of connected nodes with normalization after each update (see Zhu equation 3). Variations on this method include using smoothing parameters (see Zhu equation 5), “clamping” the labeled data (not allowing the originally labeled data to change, as Zhu recommends in section 2.2), unclamping the labeled data (not accepting the original labels as necessarily true), and others.

Propagation is an iterative process. During each iteration the label of each node is probabilistically updated to be more like the labels of its neighbors (metaphorically, the labels propagate from the neighbors to the node in question). The iterating ends when some stopping criteria are met. There are different stopping criteria. The simplest is to simply stop after a certain number of iterations. The most common is convergence, meaning we stop when the label values stop changing, or only change by some very small amount. The final labels are probabilistic, and can be interpreted as soft labels (40% “bad”, 60% “good”) or as hard labels (taking the highest valued label, so “good” in the 40/60 split above). A preferred embodiment uses hard labels, but a machine learning algorithm could take soft labels as input.

### EXAMPLE

For the purposes of a simplified hypothetical example that demonstrates the interworking of the clinical label propagation module 10, assume a data set having only two dimensions: (1) the number of CPT codes assigned to an encounter by the auto-coder engine, and (2) the number of ICD codes assigned to an encounter by the auto-coder. Assume the following data of Table 1, comprised of ten encounters with the noted assigned CPT and ICD codes. Six of the encounters have been labeled as good or bad; this example will use label propagation to label the other four, unlabeled encounters.

TABLE 1

| Encounter | CPTs | ICDs | Category |
|---|---|---|---|
| 1 | 1 | 1 | good |
| 2 | 1 | 2 | ? |
| 3 | 1 | 3 | goods |
| 4 | 1 | 6 | bad |
| 5 | 2 | 1 | ? |
| 6 | 2 | 2 | good |
| 7 | 3 | 2 | good |
| 8 | 4 | 4 | bad |
| 9 | 3 | 5 | ? |
| 10 | 4 | 6 | ? |

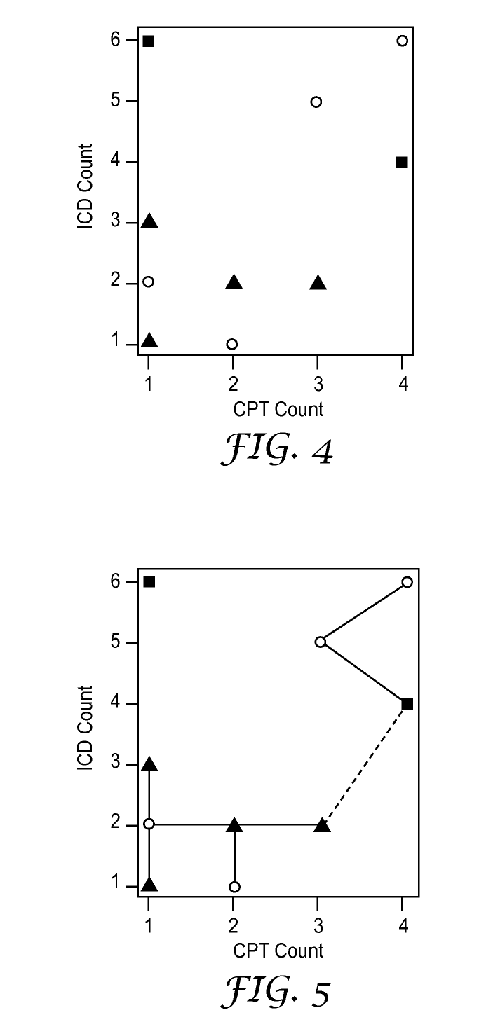

This data is represented in FIG. 4. The triangle points represent “good” encounters and the squares represent “bad.” The circle points are unlabeled.

For the sake of the example, a distance will be used that is based on the Euclidean distance between the encounters in the vector space defined by the CPT and ICD counts—that is, the normal physical distance in a two dimensional plane:

dist=\sqrt{(CPT₁−CPT₂)²+(ICD₁−ICD₂)²}

The simple Euclidean distances between each pair of points represented in FIG. 4 is given in the table below:

TABLE 2

| | 1 | 2 | 3 | 4 | 5 | 6 | 7 | 8 | 9 |
|---|---|---|---|---|---|---|---|---|---|
| 2 | 1.000 | | | | | | | | |
| 3 | 2.000 | 1.000 | | | | | | | |
| 4 | 5.000 | 4.000 | 3.000 | | | | | | |
| 5 | 1.000 | 1.414 | 2.236 | 5.099 | | | | | |
| 6 | 1.414 | 1.000 | 4.414 | 4.123 | 1.000 | | | | |
| 7 | 2.236 | 2.000 | 2.236 | 4.472 | 1.414 | 1.000 | | | |
| 8 | 4.243 | 3.606 | 3.162 | 3.606 | 3.606 | 2.828 | 2.236 | | |
| 9 | 4.472 | 3.606 | 2.828 | 2.236 | 4.123 | 3.162 | 3.000 | 1.414 | |
| 10 | 5.831 | 5.000 | 4.243 | 3.000 | 5.385 | 4.472 | 4.123 | 2.000 | 1.414 |

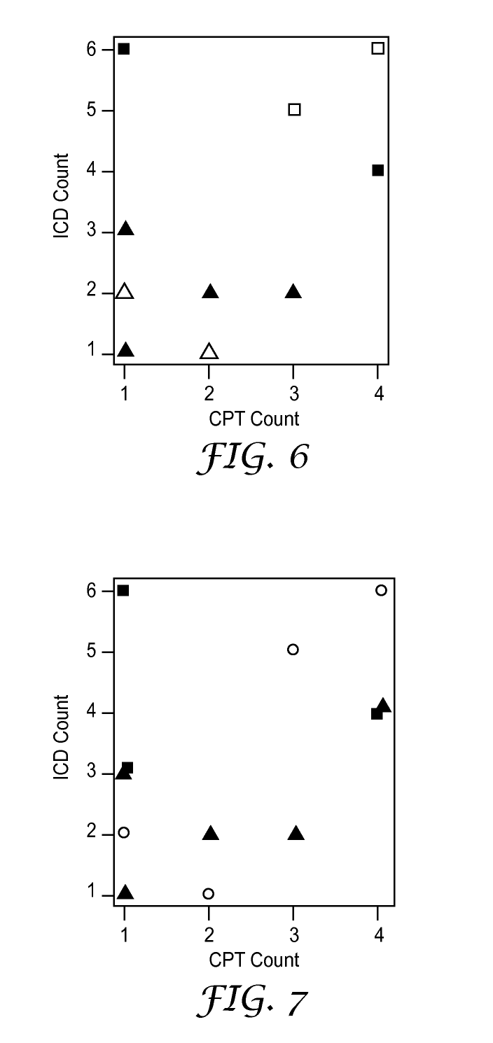

We next build the minimum spanning tree until sub-trees containing good and bad labels are connected. In our simplified example, the dashed line in the figure below connecting nodes 7 (3 CPTs, 2 ICDs) and 8 (4 CPTs and 4 ICDs) is the one that does so, and its length specifies d0, which in turn determines a, which is used to determine the weighted connections between all nodes in the network. A minimum spanning tree is shown in FIG. 5. The labels may then be assigned based on label propagation around the weighted network—the newly assigned labels are shown as hollow points in FIG. 6, with hollow squares representing newly assigned “bad” labeled nodes, and hollow triangles representing newly assigned “good” labeled nodes.

As mentioned above, however, an issue encountered with clinical encounter type data is that the data may be less consistent than desired—for example, one must deal with the possibility (and reality) that a label associated with a first encounter is “good” and a label associated with a second encounter (having the same features as the first encounter) is “bad.” Such a condition is shown in FIG. 7, which shows a simplified graph with two additional encounters added to the hypothetical 10, the two being identical to encounter 3 and 8 but having opposite labels. (The overlapping points are shown slightly offset in FIG. 7 for clarity).

Ordinarily in such a scenario (identical encounters, opposite labels), under Zhu's teachings, this condition would result in d0 being 0, which in turn means σ is 0, which either causes a division by zero error, or causes all weights to become exp(−∞)=0, which effectively prevents labels from propagating around the network.

However, under the teachings described earlier herein, the minimum spanning tree algorithm runs as before, but with different stopping criteria designed to accommodate this inconsistent data. (The exact stopping criteria previously specified would not be appropriate for this simplified data because of the low dimensionality, small number of nodes, percentage of nodes with labels, etc., but we can still see the relative values of label entropy and number of nodes involved).

In this case, the upper sub-tree has one node labeled “good” (50%) and one labeled “bad” (50%) and so has entropy of 1.00 (H(X)=−[(0.5*log₂(0.5))+(0.5*log₂(0.5))]), which is very high, but only two labeled nodes are involved.

The lower sub-tree has four nodes labeled “good” (80%) and one labeled “bad” (20%) and so has entropy of 0.72 (H(X)=−[(0.2*log₂(0.2))+(0.8*log₂(0.8))]), which is lower, but more labeled nodes are involved.

When those two sub-trees are connected, the new sub-tree has five nodes labeled “good” (71.4%) and two labeled “bad” (28.6%) and so has entropy of 0.86 (H(X)=−[(0.286*log₂(0.286))+(0.714*log₂(0.714))]), which is higher than the lower sub-tree, and has many more nodes involved.

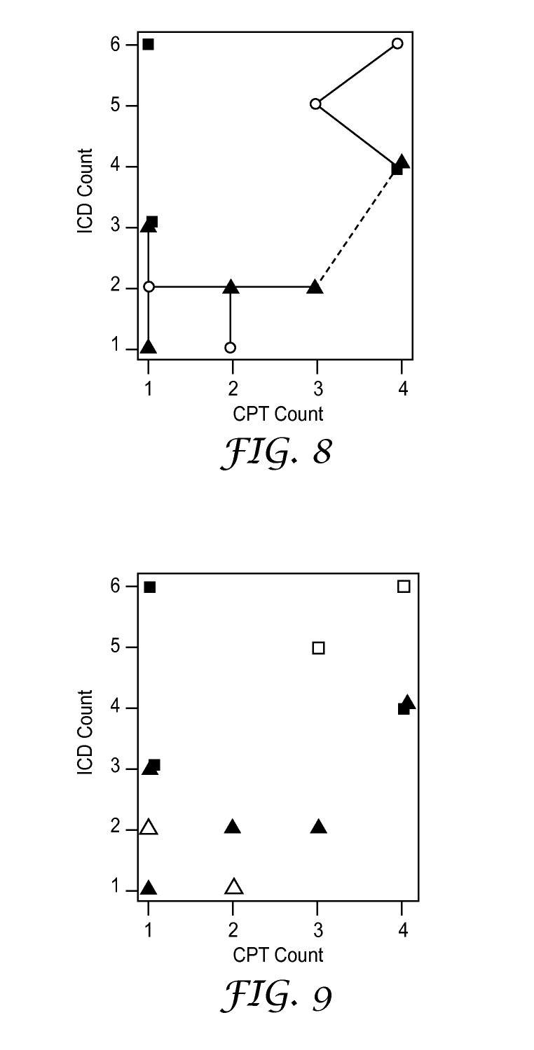

Thus the resultant minimum spanning tree is shown in FIG. 8, and resultant label propagation results are shown in FIG. 9. Effectively, the entropy-approach employed for overlapping, inconsistent data weighed more nodes to effectively determine a.

Though the embodiments described herein mostly relate to labeling patient encounter data to build a training data set, the certain of the techniques can be read to be more broadly applicable to propagating labels to any set of unlabeled patient encounter data.

Unless otherwise indicated, all numbers expressing quantities, measurement of properties, and so forth used in the specification and claims are to be understood as being modified by the term “about”. Accordingly, unless indicated to the contrary, the numerical parameters set forth in the specification and claims are approximations that can vary depending on the desired properties sought to be obtained by those skilled in the art utilizing the teachings of the present application. Not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, to the extent any numerical values are set forth in specific examples described herein, they are reported as precisely as reasonably possible. Any numerical value, however, may well contain errors associated with testing or measurement limitations.

Various modifications and alterations of this invention will be apparent to those skilled in the art without departing from the spirit and scope of this invention, and it should be understood that this invention is not limited to the illustrative embodiments set forth herein. For example, the reader should assume that features of one disclosed embodiment can also be applied to all other disclosed embodiments unless otherwise indicated. It should also be understood that all U.S. patents, patent application publications, and other patent and non-patent documents referred to herein are incorporated by reference, to the extent they do not contradict the foregoing disclosure.

1. A computer-implemented method of propagating labels to a set of clinical encounter data, the computer having at least one processor and memory, comprising:
receiving a set of labeled coded encounter data, each coded encounter including encounter-related features associated with a patient's encounter with a healthcare organization and a set of codes associated with the encounter-related features, and each coded encounter including a label indicative of a label attribute;
receiving a set of unlabeled patient encounter data; and,
using at least one of the computer's processors, algorithmically propagating labels to the set of unlabeled patient encounter data based on the set of labeled patient encounter data, to produce resulting labeled coded encounter data.

2. The computer-implemented method of claim 1, further comprising:
combining the resulting coded encounter data with the labeled coded encounter data to produce a set of training data.

3. The computer-implemented method of claim 1, wherein for each coded encounter, the label is indicative of agreement between the codes associated with an individual encounter and codes selected by a human coder for the same individual encounter, based upon the human coder's review of the patient encounter data.

4. The computer implemented method of claim 3, wherein the label is either indicative of “good” or “bad”, the label indicative of “good” signifying agreement, and the label of “bad” signifying the lack of agreement.

5. The computer-implemented method of claim 1, wherein the codes comprise Current Procedure Terminology codes and/or International Classification of Disease codes.

6. The computer-implemented method of claim 2, further comprising:
outputting the set of training data.

7. The computer-implemented method of claim 2, further comprising:
training a confidence assessment module using the training patient encounter data using machine learning techniques.

8. The computer-implemented method of claim 1, wherein algorithmically propagating labels to the set of unlabeled patient encounter data comprises:
algorithmically representing the labeled and unlabeled data as nodes in vector space network, the distance between the nodes a function of the similarity of the encounter-related features;
computing a minimum spanning tree through the nodes to define neighboring nodes; and,
assigning a label to unlabeled nodes based on the similarity of the unlabeled node to neighboring nodes.

9. The computer-implemented method of claim 8, wherein algorithmically representing the labeled and unlabeled data as nodes in a vector space network comprises having at least two overlapping nodes that have different labels, and wherein computing the minimum spanning tree comprises defining a stopping criteria for the minimum spanning tree, and wherein the stopping criteria accommodate overlapping nodes having different labels.

10. The computer-implemented method of claim 8, wherein the stopping criteria for the minimum spanning tree is based on the homogeneity and size of sub-trees.

11. A system for propagating labels to a set of clinical encounter data, the system implemented on a computer having at least one processor and memory, comprising:
a first storage module containing labeled coded encounter data, each coded encounter including encounter-related features associated with a patient's encounter with a healthcare organization and a set of codes associated with the encounter-related features, and each coded encounter including a label indicative of a label attribute;
a second storage module containing unlabeled coded encounter data; and,
a software-implemented label propagation module operative to:
(a) receive a set of labeled coded encounter data from the first storage module;
(b) receive a set of unlabeled patient encounter data from the second storage module; and,
(c) algorithmically propagate labels to the set of unlabeled patient encounter data based on the set of labeled patient encounter data, to produce resulting labeled coded encounter data.

12. The system of claim 11, wherein the software-implemented label propagation module is further operative to:
combine the resulting coded encounter data with the labeled coded encounter data to produce a set of training data.

13. The system of claim 11, wherein for each coded encounter, the label is indicative of agreement between the codes associated with an individual encounter and codes selected by a human coder for the same individual encounter, based upon the human coder's review of the patient encounter data.

14. The system of claim 13, wherein the label is either indicative of “good” or “bad”, the label indicative of “good” signifying agreement, and the label of “bad” signifying the lack of agreement.

15. The system of claim 11, wherein the codes comprise Current Procedure Terminology codes and/or International Classification of Disease codes.

16. The system of claim 12, further comprising:
outputting the set of training data.

17. The system of claim 12, further comprising:
training a confidence assessment module using the training patient encounter data using machine learning techniques.

18. The system of claim 11, wherein to algorithmically propagate labels to the set of unlabeled patient encounter data comprises:
algorithmically representing the labeled and unlabeled data as nodes in vector space network, the distance between the nodes a function of the similarity of the encounter-related features;
computing a minimum spanning tree through the nodes to define neighboring nodes; and, assigning a label to unlabeled nodes based on the similarity of the unlabeled node to neighboring nodes.

19. The system of claim 18, wherein algorithmically representing the labeled and unlabeled data as nodes in a vector space network comprises having at least two overlapping nodes that have different labels, and wherein computing the minimum spanning tree comprises defining a stopping criteria for the minimum spanning tree, and wherein the stopping criteria accommodate overlapping nodes having different labels.

20. The system of claim 19, wherein the stopping criteria for the minimum spanning tree is based on the homogeneity and size of sub-trees.
